(19) United States
(12) Patent Application Publication
(10) Pub. No.: US 2024/0340651 A1
(43) Pub. Date: Oct. 10, 2024

(54) SIDELINK COMMUNICATION ON MULTIPLE UNLICENSED CARRIERS

(71) Applicant: ZTE CORPORATION, Shenzhen (CN)

(72) Inventors: Wei LUO, Shenzhen (CN); Lin CHEN, Shenzhen (CN); Youxiong LU, Shenzhen (CN)

(21) Appl. No.: 18/749,545

(22) Filed: Jun. 20, 2024

Related U.S. Application Data
(63) Continuation of application No. PCT/CN2021/140699, filed on Dec. 23, 2021.

(51) Int. Cl. H04W 16/14; H04W 72/563; H04W 92/18

(52) U.S. Cl. CPC H04W 16/14; H04W 72/563; H04W 92/18

(57) ABSTRACT

This document generally relates to a method for wireless communication. The method includes: selecting, with a first user device, a carrier to be a licensed carrier or an unlicensed carrier for a sidelink transmission; and transmitting, with the first device, a sidelink signal on a channel in the selected carrier to a second user device.

### CROSS-REFERENCE TO RELATED APPLICATIONS

The present application is a bypass continuation application of International Application No. PCT/CN2021/140699, filed on Dec. 23, 2021, which is hereby incorporated by reference in its entirety.

### TECHNICAL FIELD

This document is directed generally to sidelink transmissions in wireless communications.

### BACKGROUND

Wireless communications are often performed with user terminal devices and base stations. In addition, wireless communication is performed on carriers or frequency bands. Some carriers are licensed carriers, which are carriers licensed by a governmental or other authoritative entity to a service provider for exclusive use. Other carriers are unlicensed carriers, which are carriers not licensed by such governmental or other authoritative entities. Currently, user terminal devices communicate directly with each other (i.e., without use of a base station) on licensed carriers. However, ways for user terminal devices to communicate directly with each other on unlicensed carriers may be desirable.

### SUMMARY

This document relates to methods, systems, apparatuses and devices for wireless communication. In some implementations, a method for wireless communication includes: selecting, with a first user device, a carrier to be a licensed carrier or an unlicensed carrier for a sidelink transmission; and transmitting, with the first device, a sidelink signal on a channel in the selected carrier to a second user device.

In some other implementations, a device, such as a network device, is disclosed. The device may include one or more processors and one or more memories, wherein the one or more processors are configured to read computer code from the one or more memories to implement the method above.

In yet some other implementations, a computer program product is disclosed. The computer program product may include a non-transitory computer-readable program medium with computer code stored thereupon, the computer code, when executed by one or more processors, causing the one or more processors to implement the method above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 shows a block diagram of an example configuration of layer entities for a communication node.

FIG. 3 shows a flow chart of an example method for wireless communication that includes selecting a carrier for a sidelink transmission.

### DETAILED DESCRIPTION

The present description describes various embodiments of systems, apparatuses, devices, and methods for wireless communications involving sidelink transmissions, including those in unlicensed carriers.

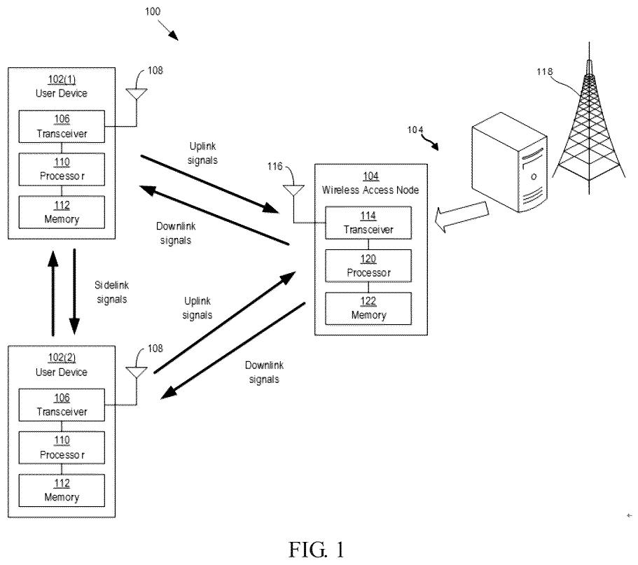

FIG. 1 shows a diagram of an example wireless communication system 100 including a plurality of communication nodes (or just nodes) that are configured to wirelessly communicate with each other. In general, the communication nodes include at least one user device 102 and at least one wireless access node 104. The example wireless communication system 100 in FIG. 1 is shown as including two user devices 102, including a first user device 102(1) and a second user device 102(2), and one wireless access nodes 104. However, various other examples of the wireless communication system 100 that include any of various combinations of user devices 102 and wireless access nodes 104, including two or more user devices 102 without any wireless access nodes 104, only one user device 102 and only one wireless access node 104, only one user device 102 and two or more wireless access nodes 104, two or more user devices 102 and one or more wireless access nodes 104, or two or more wireless access nodes 104 without any user devices 102.

In general, a user device as described herein, such as the user devices 102, may include a single electronic device or apparatus, or multiple (e.g., a network of) electronic devices or apparatuses, capable of communicating wirelessly over a network. A user device may comprise or otherwise be referred to as a user terminal, a user terminal device, or a user equipment (UE). Additionally, a user device may be or include, but not limited to, a mobile device (such as a mobile phone, a smart phone, a smart watch, a tablet, a laptop computer, vehicle or other vessel (human, motor, or engine-powered, such as an automobile, a plane, a train, a ship, or a bicycle as non-limiting examples) or a fixed or stationary device, (such as a desktop computer or other computing device that is not ordinarily moved for long periods of time, such as appliances, other relatively heavy devices including Internet of things (IoT), or computing devices used in commercial or industrial environments, as non-limiting examples). In various embodiments, a user device 102 may include transceiver circuitry 106 coupled to an antenna 108 to effect wireless communication with the wireless access node 104. The transceiver circuitry 106 may also be coupled to a processor 110, which may also be coupled to a memory 112 or other storage device. The memory 112 may store therein instructions or code that, when read and executed by the processor 110, cause the processor 110 to implement various ones of the methods described herein.

Additionally, in general, a wireless access node as described herein, such as the wireless access node 104, may include a single electronic device or apparatus, or multiple (e.g., a network of) electronic devices or apparatuses, and may comprise one or more base stations or other wireless network access points capable of communicating wirelessly over a network with one or more user devices and/or with one or more other wireless access nodes 104. For example, the wireless access node 104 may comprise a 4G LTE base station, a 5G NR base station, a 5G central-unit base station, a 5G distributed-unit base station, a next generation Node B (gNB), an enhanced Node B (eNB), or other similar or next-generation (e.g., 6G) base stations, in various embodiments. A wireless access node 104 may include transceiver circuitry 114 coupled to an antenna 116, which may include an antenna tower 118 in various approaches, to effect wireless communication with the user device 102 or another wireless access node 104. The transceiver circuitry 114 may also be coupled to one or more processors 120, which may also be coupled to a memory 122 or other storage device. The memory 122 may store therein instructions or code that, when read and executed by the processor 120, cause the processor 120 to implement one or more of the methods described herein.

In various embodiments, two communication nodes in the wireless system 100—such as a user device 102 and a wireless access node 104, two user devices 102 without a wireless access node 104, or two wireless access nodes 104 without a user device 102—may be configured to wirelessly communicate with each other in or over a mobile network and/or a wireless access network according to one or more standards and/or specifications. In general, the standards and/or specifications may define the rules or procedures under which the communication nodes can wirelessly communicate, which, in various embodiments, may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

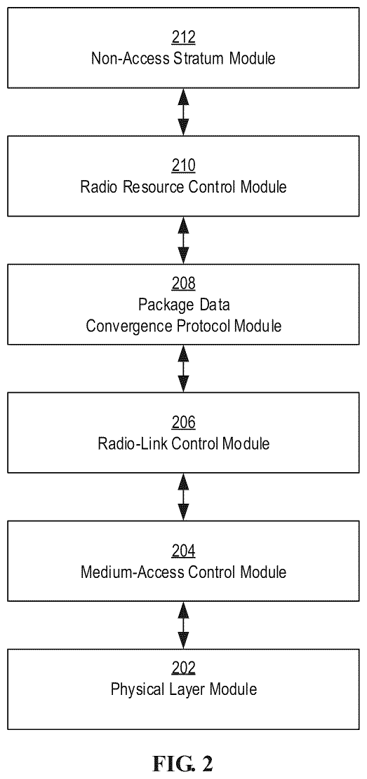

FIG. 2 shows a block diagram of a plurality of modules of a communication node (e.g., a user device 102 or a wireless access node 104), including a physical layer (PHY) entity or module (also called herein as just PHY layer, PHY module, or PHY entity) 202, a medium-access control (MAC) layer entity or module (also called herein as just MAC layer, MAC module, or MAC entity) 204, a radio-link control (RLC) layer entity or module (also called herein as just RLC layer, RLC entity, or RLC module) 206, a package data convergence protocol (PDCP) layer entity or module (also called herein as just PDCP layer, PDCP entity, or PDCP module) 208, and a radio resource control (RRC) layer entity or module (also called herein as just RRC layer, RRC entity, or RRC module) 210, and a Non-Access Stratum (NAS) layer entity or module (also called herein as just NAS layer, NAS entity, or NAS module) 212.

In general, as used herein unless expressed otherwise, the terms “layer”, “entity”, and “module”, used alone or in combination with each other, and as used for one or more components of a communication node, is an electronic device, such as electronic circuit, that includes hardware or a combination of hardware and software. In various embodiments, a module or an entity may be considered part of, or a component of, or implemented using one or more of the components of a communication node of FIG. 1, including a processor 110/120, a memory 112/122, a transceiver circuit 106/114, or the antenna 108/116. For example, the processor 110/120, such as when executing computer code stored in the memory 112/116, may perform the functions of a module or entity. Additionally, in various embodiments, the functions that a module or entity performs may be defined by one or more standards or protocols, such as 5G NR for example.

Additionally, the layer entities 202-212 in FIG. 2 may be higher and lower layers relative to each other, with the PHY layer entity 202 being the lowest layer among the layer entities 202-212; the MAC layer entity 204 being a higher layer than the PHY layer entity 202 and lower than the other layer entities 206-212; the RLC layer entity 206 being higher than the PHY and MAC layer entities 202, 204 and lower than the PDCP, RRC, and NAS layer entities 208-212; the PDCP layer entity 208 being higher than the PHY, MAC, and RLC layer entities 202-206 and lower than the RRC and NAS layer entities 210, 212; the RRC layer entity 210 being higher than the PHY, MAC, RRC, and PDCP layer entities 202-208 and lower than the NAS layer entity 212; and the NAS layer entity 212 being the highest layer entity among the layer entities 202-212 shown in FIG. 2. In various embodiments, a communication node of the system 100 may include modules and/or protocol layers other than those shown in FIG. 2.

Additionally, in various embodiments, two or more of the communication nodes in the wireless system 100, may be configured to communicate according to vehicle networking standards and/or specifications. As used herein, vehicle networking refers to a large scale system for wireless communication and information exchange involving a vehicle, pedestrians, roadside equipment and the Internet in accordance with any of various communication protocols and data exchange standards. Vehicle networking communications may enhance vehicle performance with respect to driving safety, traffic efficiency, usability or user convenience features, or entertainment. Additionally, in any of various embodiments, vehicle networking communication may be categorized into three types: communication between vehicles (also called vehicle-to-vehicle (V2V)); communication between a vehicle and roadside equipment/network infrastructure (called vehicle-to-infrastructure/vehicle-to-network (V2I/V2N)); and communication between vehicles and pedestrians (called vehicle-to-pedestrian (V2P)). These types of communications are collectively referred to as vehicle-to-everything (V2X) communication. Communication nodes participating in V2X communicates may communicate with each other according to any of various V2X standards or specifications.

In the wireless system 100, the communication nodes are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between a first node and a second node where the first node is transmitting a signal to the second node and the second node is receiving the signal from the first node, the first node may be referred to as a source or transmitting node or device, the second node may be referred to as a destination or receiving node or device, and the communication may be considered a transmission for the first node and a reception for the second node. Of course, since communication nodes in a wireless system 100 can both send and receive signals, a single communication node may be both a transmitting/source node and a receiving/destination node simultaneously or switch between being a sending node and a receiving node.

Also, particular signals can be characterized or defined as either an uplink (UL) signal, a downlink (DL) signal, or a sidelink (SL) signal. An uplink signal is a signal transmitted from a user device 102 to a wireless access node 104. A downlink signal is a signal transmitted from a wireless access node 104 to a user device 102. A sidelink signal is a signal transmitted from a one user device 102 to another user device 102, or a signal transmitted from one wireless access node 104 to a another wireless access node 104. Also, for sidelink transmissions, a first/source user device 102 directly transmits a sidelink signal to a second/destination user device 102 without any forwarding of the sidelink signal to a wireless access node 104.

For at least some embodiments involving V2X communication, user devices 102 may perform sidelink transmissions. Such sidelink communications in V2X may be referred to as a PC5-based V2X communication or V2X communication. Additionally, for sidelink communications in V2X, user device 102 may communicate sidelink signals to each other using a PC5 interface, where PC5 refers to a reference point where a user device 102 communicates with another user device 102 over a direct channel.

As V2X technology advances, including in the automation industry, scenarios for V2X communications are being increasingly diversified and require higher performance. Examples of advanced V2X services include vehicle platooning, extended sensors, advanced driving (semi-automated driving and full-automated driving), and remote driving. Example performance requirements for these advanced V2X services may include: supporting data packets with a size of 50 to 12,000 bytes, a transmission rate of 2 to 50 messages per second, a maximum end-to-end delay of 3 to 500 milliseconds, a reliability of 90% to 99.999%, a date rate of 0.5 to 1,000 Megabytes per second (Mbps), or a transmission range of 50 to 1,000 meters, as non-limiting examples.

In addition, communication nodes using NR radio access operating with shared spectrum channel access may be configured to operate in different modes, where primary cells (PCells), primary secondary cells (PSCells) or secondary cells (SCells) can be in the shared spectrum, and an SCell may or may not be configured with uplink transmissions. Further, in both channel access modes, the wireless access node 104 and the user device 102 may be configured to apply or perform listen-before-talk (LBT) procedures before performing a transmission on a cell configured with shared spectrum channel access.

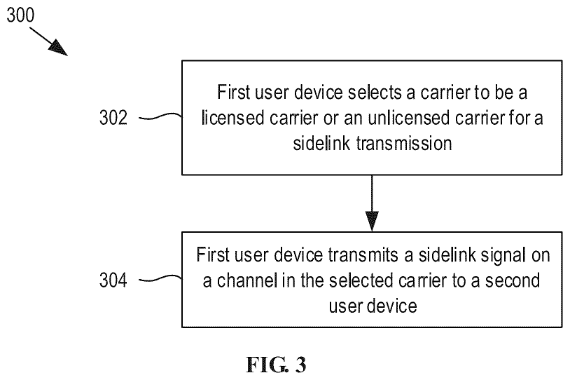

In event that the wireless access node 104 provides multiple sidelink carriers (i.e., carriers in which a user device can perform a sidelink transmission and/or communicate (transmit or receive) sidelink signals with another user device) and associated one or more pools of resources to a user device, the user device may determine how to select one or more of the multiple carriers for the sidelink transmission. The following embodiments with respect to FIG. 3 describe various embodiments related to a user device may select one or more of multiple carriers for one or more sidelink transmissions.

FIG. 3 shows an example method 300 for wireless communication that includes sidelink communication between the first user device 102(1) and the second user device 102(2) on an unlicensed carrier. The embodiments of the method 300 have the first user device 102(1) functioning as a source or transmitting user device that transmits a sidelink signal to the second user device 102(2), and the second user device 102(2) functioning as a destination or receiving user device that receives the sidelink signal from the first user device 102(1).

Also, in general, a licensed carrier is a carrier, frequency band or spectrum that is licensed by a government or other authoritative entity (e.g., the Federal Communications Commission (FCC) in the United States or the European Telecommunications Standards Institute (ETSI) in Europe) to a service provider for exclusive use. An unlicensed carrier, also called a shared spectrum, is a carrier, frequency band or spectrum that is not licensed by a government or other authoritative entity.

At block 302, the first user device 102(1) may select a carrier for a sidelink transmission to be a licensed carrier or an unlicensed carrier. In at least some embodiments, the selection performed at block 302 may also be called a reselection of a carrier, including situations where the first user device 102(1) previously selected a carrier. Hereafter, for simplicity, unless expressed otherwise, carrier selection by a user device also includes those situations that can be considered carrier reselection. At block 304, the first user device 102(1) may transmit a sidelink signal on a channel in the carrier selected at block 302 to the second user device 102(2).

Additionally, in some embodiments, the first user device 102(1) may be configured with a mapping of V2X service types to sidelink frequencies (which may include licensed frequencies (frequencies of licensed carriers) and/or unlicensed frequencies (frequencies of unlicensed carriers)). In other embodiments, the first user device 102(1) may be configured with a mapping of destination Layer-2 identifications (ID) to sidelink frequencies (licensed and/or unlicensed). In general, a user device may have one or more Layer-2 IDs for V2X communication over a PC5 reference point, which may include one or more source Layer-2 IDs and one or more destination Layer-2 IDs. Source and destination Layer-2 IDs may be included in layer-2 frames sent on the layer-2 link of the PC5 reference point identifying the layer-2 source and destination of these frames. The selection of source and destination Layer-2 IDs by a user device may depend on a communication mode of the V2X communication over PC5 reference point for the layer-2 link. Additionally, in various embodiments, the first user device 102(1) may be preconfigured with the mapping of V2X service types to sidelink frequencies and/or the mapping of Destination Layer 2 ID(s) to sidelink frequencies, a Universal Integration Circuit Card (UICC) may be configured with one or both of the mappings, combinations thereof, one or both of the mappings may be provided or updated by a V2X Application Server via Policy Control Function (PFC) and/or V1 reference point, and/or provided by the PCF to the first user device 102(1), such as in accordance with any of various standards, specification, or protocols, including any related to 3GPP, NR, and/or V2X.

Also, in some embodiments, in event that the first user device 102(1) has any traffic (data and/or signals to be transmitted) that belongs to a destination Layer-2 ID that is mapped to an unlicensed carrier, the first user device 102(1) may select the unlicensed carrier. However, in event that the first user device 102(1) detects a sidelink consistent listen-before-talk (LBT) failure on a sidelink unlicensed carrier, the first user device 102(1) may determine that the sidelink unlicensed carrier is not be candidate carrier. In general, as used herein, a candidate carrier is a carrier that may be an option for a user device to select for a transmission.

Additionally, in various embodiments, in event that the first user device 102(1) has traffic that belongs to a destination Layer-2 ID that can be mapped to both an unlicensed carrier and a licensed carrier, the first user device 102(1) may select the licensed carrier or the unlicensed carrier. However, in event that the first user device 102(1) detects a sidelink consistent LBT failure for the unlicensed carrier, the first user device 102(1) may determine that the unlicensed carrier is not to be a candidate carrier.

Additionally, in various embodiments, in event that the first user device 102(1) has traffic that belongs to a destination Layer-2 ID that is mapped to an unlicensed carrier and the first user device 102(1) also has traffic that belongs to a destination Layer-2 ID that is mapped to a licensed carrier, the first user device 102(1) may select the licensed carrier or the unlicensed carrier. However, in event that the first user device 102(1) detects a sidelink consistent LBT failure for the unlicensed carrier, the first user device 102(1) may determine that the unlicensed carrier is not to be a candidate carrier.

Also, for at least some embodiments, at block 302, after the first user device 102(1) selects the carrier (licensed or unlicensed), the first user device 102(1) may report the selected carrier, including information about or indicating the selected carrier for each destination identification (ID) (e.g., of the second user device 102(2) or a connection between the first and second user devices), to the wireless access node 104. Also, for at least some embodiments, the first user device 102(1) may report the selected carrier in event that the first user device 102(1) is a RRC-connected user device. In addition or alternatively, for at least some embodiments, the first user device 102(1) may report the selected carrier for each destination ID via UE assistant information or sidelink UE information.

Additionally, in various embodiments, the first user device 102(1) may be configured with, and/or be configured to select, multiple sidelink carriers. As mentioned, a sidelink carrier is a carrier that a user device may use for a sidelink transmission. Also, for at least some embodiments, the multiple sidelink carriers, may include at least one unlicensed carrier and at least one licensed carrier.

Also, in various embodiments, the first user device 102(1) may be configured with a sidelink priority threshold (sl-PriorityThresh), such as in the form of an information element (IE). At block 302, for some embodiments, the first user device 102(1) may identify that a value of the highest priority of one or more logical channels in a MAC protocol data unit (PDU) of the sidelink signal is lower than a value of the sidelink priority threshold. In response to the identification, the first user device 102(1) may select the licensed carrier instead of the unlicensed carrier to perform the sidelink transmission. Additionally, in event that the first user device 102(1) identifies that the value of the highest priority of the one or more logical channels in the MAC PDU is higher than the value of the sidelink priority threshold, then the first user device 102(1) may select the unlicensed carrier for the sidelink transmission. In other embodiments, the first user device 102(1) may select the licensed carrier instead of the unlicensed carrier as the carrier for the sidelink transmission in event that the MAC PDU of the sidelink signal includes a sidelink signaling radio bearer (SRB) or a sidelink MAC control element (CE).

Additionally, in various embodiments, the first user device 102(1) may be configured with the sidelink priority threshold by receiving the sidelink priority threshold from another communication node, such as the wireless access node 104. In other embodiments, the first user device 102(1) may be preconfigured with the sidelink priority threshold. As used herein, by a communication node being preconfigured with certain information, such as a sidelink priority threshold, the communication node may be able to determine the information or access the information without having to receive the information from another communication node, such as during operation in the wireless communication system 100. In addition or alternatively, in various embodiments, in event that the first user device 102(1) is in a RRC-connected state, the first user device 102(1) may acquire the sidelink priority threshold via a RRC message from the wireless access node 104; in event that the first user device 102(1) is in a RRC idle state, the first user device 102(1) may acquire the sidelink priority threshold via system information from the wireless access node 104; and in event that the first user device 102(1) is out of coverage, the first user device 102(1) may be preconfigured with the sidelink priority threshold.

Also, in some embodiments, the first user device 102(1) may receive a list of allowed carriers from which the first user device 102(1) may select for the carrier for the sidelink transmission at block 302. The first user device 102(1) may receive the list from another communication node, such as the wireless access node 104 for example. Additionally, in various embodiments, the allowed carriers in the list may include at least one licensed carrier and at least one unlicensed carrier. Also, in various embodiments, the list may be included in a sidelink logical channel configuration that is used to configured sidelink logical channel parameters. Additionally, each carrier in the list may be mapped to a respective one of a one or more logical channels. For example, a first carrier may be mapped to a first logical channel, a second carrier may be mapped to a second logical channel, and so on. The carrier that the first user device 102(1) selects at block 302 may be a carrier indicated in the list.

In other embodiments, the first user device 102(1) may receive indication information that indicates one or more sidelink logical channels. For at least some embodiments, the indication information may be included in the logical channel configuration. Additionally, the indication information may indicate whether each sidelink logical channel (or data of each sidelink logical channel), of the one or more sidelink logical channels, is allowed to be transmitted on an unlicensed carrier or a licensed carrier. Correspondingly, at block 302, the first user device 102(1) may determine a first sidelink logical channel for the sidelink transmission. In turn, the first user device 102 may determine whether the first sidelink channel is allowed to be transmitted on the licensed carrier or the unlicensed carrier based on the indication information, and then select the carrier to be the licensed carrier or the unlicensed carrier based on the indication information. For example, if the indication information indicates that the first sidelink channel is allowed to be transmitted on the unlicensed carrier, then the first user device 102(1) selects the unlicensed carrier; and if the indication information indicates that the first sidelink channel is allowed to be transmitted on the licensed carrier, then first user device 102(1) selects the licensed carrier.

Additionally, in at least some of the embodiments, the first user device 102(1) may perform a logical channel prioritization (LCP) procedure. During the LCP, the first user device 102(1) may determine a first logical channel, or determine to select the first logical channel, according to prioritization performed during the LCP procedure. For at least some of these embodiments, at block 302, the first user device 102(1) may determine or select the carrier, such as previously described. Additionally, and/or subsequent to determining the carrier, the first user device 102(1) may perform an LCP procedure to determine or select a first sidelink logical channel. For at least some embodiments, the first user device 102(1) may select or determine the first sidelink logical channel during the LCP procedure in response to the indication information indicating that the first sidelink logical channel is allowed to be transmitted on the unlicensed carrier that the first user device 102(1) selected.

Additionally, for at least some embodiments, during a LCP procedure, the first user device 102(1) may allocate sidelink resources to those sidelink logical channels that are allowed to be transmitted on the unlicensed carrier when the acquired sidelink resources are on an unlicensed carrier.

Additionally, for at least some embodiments, the logical channel configuration information, and/or the indication information, indicates, for each sidelink logical channel, whether a sidelink MAC SDU in the logical channel is allowed to be transmitted on an unlicensed carrier.

In other embodiments, at block 302, the first user device 102(1) may select a carrier based on priority information. For example, in some embodiments, the first user device 102(1) may receive priority indication information that indicates one or more sidelink logical channels, and for each sidelink logical channel, whether an unlicensed carrier or the licensed carrier has a higher priority. The first user device 102(1) may select whichever carrier has the higher priority. For example, the first user device 102(1) may determine a first logical channel where data is available for a sidelink transmission. The first user device 102(1) may then use the priority information to determine whether the licensed carrier or the unlicensed carrier has the higher priority for the first logical channel. If the licensed carrier has a higher priority than the unlicensed carrier for the first logical channel, then the first user device 102(1) may select the licensed carrier and its associated pool of resources at block 302. In addition, if the unlicensed carrier has a higher priority than the licensed carrier for the first logical channel, then the first user device 102(1) may select the unlicensed carrier and its associated pool of resources at block 302. In various embodiments, the first user device 102(1) may perform carrier selection based on whether the licensed carrier or the unlicensed carrier has a higher priority for each logical channel where data is available to be transmitted.

Additionally, in various embodiments, the first user device 102(1) may select the licensed carrier or the unlicensed carrier at block 302 based on quality-of-service (QOS) profiles. For example, the first user device 102(1) may receive, such as from the wireless access node 104, indication information whether the licensed carrier or the unlicensed carrier is allowed to be used for a sidelink transmission for each of one or more QoS profiles. If a MAC PDU to be transmitted in the sidelink transmission includes data of any of the one or more QoS profiles indicating that the unlicensed carrier is not allowed to be used for the sidelink transmission, then the first user device 102(1) may select the licensed carrier. Additionally, if the MAC PDU includes data of any of the one or more QoS profiles indicating that the licensed carrier is not allowed to be used for the sidelink transmission, then the first user device 102(1) may select the unlicensed carrier. Also, for at least some of these embodiments that select carriers based on QoS profiles, the first user device 102(1) may receive a list of QoS profiles, such as from the wireless access node 104. The first user device 102(1) may select the licensed carrier or the unlicensed carrier and an associated pool of resources based on a MAC PDU including data of the QoS profiles that indicates whether the licensed carrier or the unlicensed carrier is not allowed for the sidelink transmission.

Additionally, in various embodiments, the first user device 102(1) may select the licensed carrier or the unlicensed carrier at block 302 based on a list sidelink logical channels. In various embodiments, the first user device 102(1) may receive the list from the wireless access node 104. Additionally, in the list, each sidelink logical channel may indicate whether the licensed carrier or the unlicensed carrier is allowed to be used for the sidelink transmission. For these embodiments, the first user device 102(1) may determine that a first sidelink logical channel is included in a MAC PDU for the sidelink transmission. In response to the determination, the first user device 102(1) may identify the first sidelink logical channel in the list, and then identify whether the licensed carrier or the unlicensed carrier is allowed to be used for the sidelink transmission for the first sidelink logical channel. For example, if the list indicates that the licensed carrier is allowed for the first sidelink logical channel, then the first user device 102(1) may select the licensed carrier; and if the list indicates that the unlicensed carrier is allowed for the first sidelink logical channel, then the first user device 102(1) may select the unlicensed carrier.

Additionally, in various embodiments, including those where the first user device 102(1) is configured in a UE-Selected resource allocation mode or the first user device 102(1) is configured in a RRC-idle state, in event that the first user device 102(1) detects a sidelink consistent LBT failure, the first user device 102(1) may determine to change to another or new carrier or bandwidth part to perform a sidelink communication. In general, when communicating in an unlicensed carrier, the first user device 102(1) may perform a LBT procedure that listens to or senses a channel to determine if the channel in the unlicensed carrier is available (free) or busy. If the channel is free, then the first user device 102(1) may determine that a result of the LBT procedure is a LBT success, and in turn proceed to perform a transmission on the channel. If the channel is busy, then the first user device 102(1) may determine that a result of the LBT procedure is a LBT failure, and determine not to perform the transmission. Additionally, the first user device 102(1) may keep track of a number or count of LBT failures for a channel, carrier, bandwidth part, or a destination identification (ID) of a second user device 102(2) and/or a PC5-RRC connection that the first user device 102(1) establishes with the second user device 102(2). If the count reaches a LBT failure maximum count or threshold, then the first user device 102(1) may detect a consistent LBT failure for the channel, carrier, bandwidth part, or destination ID. In various embodiments, the PHY layer 202 of the first user device 102(1) may perform LBT procedures, and report the results of the LBT procedures to the MAC layer 204. Correspondingly, the MAC layer may detect for consistent LBT failures, such as by keeping track of current count of LBT failures and determining whether the current count has reached a maximum count.

For at least some embodiments, at block 302, the first user device 102(1) may detect for sidelink consistent LBT failures for a carrier, a bandwidth part, or a destination ID. The carrier selection that the first user device 102(1) performs at block 302 may be performed in response to detection of a sidelink consistent LBT failure. In this context, the selection may be a reselection of the carrier to be a licensed carrier or an unlicensed carrier. Also, for at least some of these embodiments, the first user device 102(1) may clear a grant associated with the sidelink transmission, and/or flush a hybrid automatic repeat request (HARQ) buffer associated with the sidelink transmission.

In other embodiments, the first user device 102(1) may keep track of a current count of LBT failures, a maximum count and a timer associated with LBT failures detections. The first user device 102(1) may be configured to start the timer, such as in response to an initial LBT failure detection. Also, if the first user device 102(1) detects a LBT failure, the first user device 102(1) may increment the current count, and then determine whether the current count has reached the maximum count. At block 302, the first user device 102(1) may determine to select or reselect the carrier for a sidelink transmission in response to the current count reaching the maximum count. Also, for at least some of these embodiments, the current count of LBT failures, the maximum count, and/or the timer may be managed by the first user device 102(1) independent of and/or irrespective of detecting for consistent LBT failure. For example, in various embodiments, the maximum count here may be the same as or different than the maximum count used for detecting consistent LBT failures. Also, in various embodiments, the first user device 102(1) may be configured with the maximum count by receiving the maximum count from another communication node, such as from the wireless access node 104, or may be preconfigured with the maximum count.

Additionally, in various embodiments, the first user device 102(1) may determine one or more candidate carriers for selection/reselection performed by the first user device 102(1) at block 302. The determination of one or more candidate carrier may be performed as part of block 302. For example, at block 302, the first user device 102(1) may determine or be triggered to select a carrier. In response to the determination, the first user device 102(1) may determine one or more candidate carriers for selection/reselection. Then, the user device 102(1) may select/reselect a carrier from the one or more candidate carriers.

For some embodiments, at block 302, before the first user device 102(1) selects a licensed carrier or an unlicensed carrier as the carrier for the sidelink transmission, the user device 102(1) may identify a given unlicensed carrier as a candidate carrier for selection in response to: a number of LBT failure indications being lower than a predetermined value during a last time window, the first user device 102(1) being configured with a UE-selected resource allocation mode when a LBT Failure Recovery is determined for the given unlicensed carrier a destination ID, or a sidelink bandwidth part (BWP), or a result of a LBT procedure for the given unlicensed carrier, the destination ID, or the sidelink BWP being a LBT success.

In particular examples of these embodiments, when the first user device 102(1) determines to perform carrier selection at block 302, if no sidelink grants are configured for any carrier allowed for a sidelink channel where data is available (e.g., as indicated one or more upper layers (MAC layer 204 or higher), then for each carrier associated with a sidelink logical channel having data available for a sidelink transmission, if a channel busy rate (CBR) of a given carrier is below a predetermined threshold (threshCBR-FreqReselection) associated with a priority of the sidelink channel, and if the given carrier is not an unlicensed carrier, the first user device 102(1) may consider or identify the given carrier as a candidate carrier for selection/reselection of the carrier for the sidelink transmission of the data of the sidelink logical channel at block 302. Also, if the given carrier is an unlicensed carrier, during a last time window n (e.g., a time duration between a time (x-n) and a current time x), if a number of LBT failure indications is lower than a predetermined value N, or if the first user device 102(1) is configured with a UE-selected resource allocation mode when a LBT Failure Recovery is determined for the given carrier or a destination ID, or a sidelink bandwidth part (BWP), then the first user device 102(1) may consider or identify the given carrier as a carrier candidate for the carrier selection/reselection performed at block 302.

Additionally, in other particular examples of these embodiments, for each of one or more logical channels, if any, where data of a given sidelink logical channel is available, and the given sidelink logical channel is allowed on a carrier for which the first user device 102(1) determines to perform carrier selection/reselection at block 302, if the CBR of the carrier is below a first threshold (threshCBR-FreqKeeping) associated with a priority of the given sidelink logical channel, the first user device 102(1) may select the carrier and its associated pool of resources. Also, for each of one or more carriers configured by one or more upper layers (e.g., the MAC layer 204 and/or one or more layers higher than the MAC layer 204) on which a given sidelink logical channel is allowed, if the CBR of a given carrier is below a second threshold (threshCBR-FreqReselection) associated with the priority of the given sidelink logical channel, if the given carrier is not an unlicensed carrier, the first user device 102(1) may consider or identify the given carrier as a candidate carrier for the carrier selection/reselection performed at block 302. Also, if the given carrier is an unlicensed carrier, during a last time window n, if a number of LBT failure indications is low than a predetermined value N, or if the user device is configured with a “UE-selected” resource allocation mode when a LBT Failure Recovery is determined for the given carrier, a destination ID, or a sidelink BWP, the first user device 102(1) may consider or identify the given carrier as a candidate carrier for the carrier selection/reselection performed at block 302.

Additionally, with respect to LBT Failure Recovery, in general, congestion in an unlicensed carrier caused by too many user devices wanting to occupy the unlicensed carrier may increase the likelihood of the first user device 102(1) detecting a LBT failure for a LBT procedure. Accordingly, it may be preferable for the first user device 102(1) to stop using the unlicensed carrier. However, after a certain amount of time has elapsed, the number of user devices wanting to occupy the unlicensed carrier may become less, at which time it may be desirable or at least feasible for the first user device 102(1) to communicate on the unlicensed carrier again. Also, if the first user device 102(1) detects a sidelink consistent LBT failure, the first user device 102(1) may report a LBT failure indication for the sidelink consistent LBT failure to the wireless access node 104. In response, the wireless access node 104 may stop allocating sidelink resources in the unlicensed carrier for the reporting first user device 102(1). However, the wireless access node 104 may not know when the number of user devices occupying the unlicensed carrier reduces (congestion in the unlicensed carrier decreases) such that it is desirable for the first user device 102(1) to again communicate on the unlicensed carrier. Accordingly, the first user device 102(1) may continue to perform LBT procedures in the unlicensed carrier after it detects a LBT failure. If, during a subsequent LBT procedure in the unlicensed carrier, it detects a LBT success, it may report the LBT success to the wireless access node 104. In response, the wireless access node 104 may allocate sidelink resources for the unlicensed carrier to the first user device 102(1). As used herein, the term LBT failure recovery for a carrier refers to a determination that that a user device can communicate in a carrier following a previous determination that the user device should not communicate in the carrier, such as due to detection of a LBT failure.

For at least some embodiments, the first user device 102(1) may determine a LBT Failure Recovery for the given unlicensed carrier in response to expiration of a timer that is started in response to detection of a consistent LBT failure for the given unlicensed carrier.

Additionally, in various embodiments, in event that the first user device 102(1) identifies one or more carriers as candidate carriers for the carrier selection/reselection performed at block 302, for each of one or more sidelink logical channels allowed on a given carrier where data is available and the first user device 102(1) determines (such as by being triggered) to perform carrier selection/reselection, the first user device 102(1) may select one or more carriers and their associated pool(s) of resources among the one or more candidate carriers according to an increasing order of CBR, starting from a lowest CBR.

In another embodiment, in event that the one or more candidate carriers for the carrier selection/reselection at block 302 include only unlicensed carriers, then the first user device 102(1) may select one or more carriers from among the candidate carriers and their associated pool(s) of resources according to an increasing order of LBT failures, starting with a lowest number of LBT failures.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

The subject matter of the disclosure may also relate to or include, among others, the following aspects:

A first aspect includes a method for wireless communication, comprising: selecting, with a first user device, a carrier to be a licensed carrier or an unlicensed carrier for a sidelink transmission; and transmitting, with the first device, a sidelink signal on a channel in the selected carrier to a second user device.

A second aspect includes the first aspect, and further includes: reporting, with the first device, information of the selected carrier to a wireless access node.

A third aspect includes any of the first or second aspects, further wherein the sidelink signal comprises a medium access control (MAC) protocol data unit (PDU), and wherein selecting the carrier comprises selecting, with the first device, the licensed carrier as the carrier for the sidelink transmission in response to a value of a highest priority of one or more logical channels in the MAC PDU being lower than a value of sidelink priority threshold.

A fourth aspect includes the third aspect, and further includes wherein selecting the carrier further comprises selecting, with the first device, the unlicensed carrier for the sidelink transmission in response to the value of the highest priority being higher than the value of the sidelink priority threshold.

A fifth aspect includes any of the third or fourth aspects, and further includes: receiving, with the first user device, the value of the sidelink priority threshold from a wireless access node.

A sixth aspect includes any of the third or fourth aspects, and further wherein the first user device is preconfigured with the sidelink priority threshold.

A seventh aspect includes any of the first through sixth aspects, and further includes wherein selecting the carrier comprises selecting, with the first device, the licensed carrier as the carrier for the sidelink transmission in response to a medium access control (MAC) protocol data unit (PDU) of the sidelink signal including a sidelink signaling radio bearer or a sidelink MAC control element (CE).

An eighth aspect includes any of the first through seventh aspects, and further includes: receiving, with the first user device, a list of allowed carriers, each of the allowed carriers mapped to a sidelink logical channel for the sidelink transmission; and wherein selecting the carrier comprises selecting, with the first user device, the carrier from the list.

A ninth aspect includes any of the first through eighth aspects, and further includes: receiving, with the first user device, indication information indicating whether each of one or more sidelink logical channels is allowed to be transmitted on the unlicensed carrier or the licensed carrier; determining, with the first user device, that the unlicensed carrier is selected; and selecting, with the first user device, a first sidelink logical channel during a logical channel prioritization (LCP) procedure in response to the indication information indicating that the first sidelink logical channel is allowed to be transmitted on the unlicensed carrier.

A tenth aspect includes any of the first through ninth aspects, and further includes: receiving, with the first user device, priority indication information indicating whether the unlicensed carrier or the licensed carrier has a higher priority for each of one or more sidelink logical channels for the sidelink transmission, wherein selecting the carrier comprises: selecting the licensed carrier and an associated pool of resources in response to the licensed carrier having the higher priority than the unlicensed carrier; and selecting the unlicensed carrier and an associated pool of resources in response to the unlicensed carrier having the higher priority than the licensed carrier.

An eleventh aspect includes any of the first through tenth aspects, and further includes: receiving, with the first user device from a wireless access node, indication information indicating whether at least one of the unlicensed carrier or the licensed carrier is allowed to be used for the sidelink transmission for each of one or more quality of service (QOS) profiles, wherein selecting the carrier comprises: selecting the licensed carrier in response to a medium access control (MAC) protocol data unit (PDU) to be transmitted including data of any of the one or more QoS profiles indicating that the unlicensed carrier is not allowed to be used for the sidelink transmission; and selecting the unlicensed carrier in response to the MAC PDU to be transmitted including data of any of the one or more QoS profiles indicating that the licensed carrier is not allowed to be used for the sidelink transmission.

A twelfth aspect includes any of the first through eleventh aspects, and further includes: receiving, with the first user device from a wireless access node, a list of quality of service (QOS) profiles, each of the QoS profiles in the list indicating whether at least one of the unlicensed carrier or the licensed carrier is allowed to be used for the sidelink transmission; and determining, with the first user device, that data of at least one QoS profile is included in a medium access control (MAC) protocol data unit (PDU), wherein selecting the carrier comprises selecting the licensed carrier or the unlicensed carrier based on the list of QoS profiles and the data of the at least one QoS profile is included in the MAC PDU.

A thirteenth aspect includes any of the first through twelfth aspects, and further includes: receiving, with the first user device from a wireless access node, a list of one or more sidelink logical channels, the list indicating whether at least one of the unlicensed carrier or the licensed carrier is allowed to be used for the sidelink transmission for each of the one or more sidelink logical channels in the list; and determining, with the first user device, a sidelink logical channel is included in a medium access control (MAC) protocol data unit (PDU) for the sidelink transmission, wherein selecting the carrier comprises selecting the licensed carrier or the unlicensed carrier based on the list of one or more sidelink logical channels and the sidelink logical channel included in the MAC PDU for the sidelink transmission.

A fourteenth aspect includes any of the first through thirteenth aspects, and further includes: detecting, with the first user device, a consistent listen-before-talk (LBT) failure for the carrier, a bandwidth part (BWP), or a destination identification, wherein selecting the carrier comprises reselecting the carrier for the sidelink transmission in response to detecting the consistent LBT failure.

A fifteenth aspect includes any of the first through fourteenth aspects, and further includes: detecting, with the first user device, a listen-before-talk (LBT) failure indication; incrementing, with the first user device, a LBT counter in response to the detecting; and in response to incrementing, determining, with the first user device, whether the LBT counter has reached a maximum count value, wherein selecting the carrier comprises reselecting, with the first user device, the carrier in response to LBT counter reaching the maximum count value.

A sixteenth aspect includes any of the first through fifteenth aspects, and further includes: before selecting the carrier, identifying, with the first user device, the unlicensed carrier as a candidate carrier in response to: a number of listen-before-talk (LBT) failure indications being lower than a predetermined value during a last time window; the first user device being configured with a user equipment (UE)-selected resource allocation mode when a LBT failure recovery is determined for the unlicensed carrier, a destination identification, or a sidelink bandwidth part (BWP); or an LBT success for the unlicensed carrier, the destination identification, or the sidelink BWP.

A seventeenth aspect includes the sixteenth aspect, and further includes: determining, with the first user device, the LBT failure recovery in response to expiration of a timer that is started in response to determining a consistent LBT failure.

An eighteenth aspect includes any of the first through seventeenth aspects, and further includes: determining, with the first user device, a plurality of candidate carriers for the sidelink transmission, the plurality of candidate carriers comprising only unlicensed carriers; and selecting, with the first user device, one or more carriers from among the plurality of candidate carriers according to an increasing order of numbers of listen-before-talk (LBT) failures for the plurality of the candidate carriers, starting from a lowest number of the numbers of LBT failures.

A nineteenth aspect includes a wireless communications apparatus comprising a processor and a memory, wherein the processor is configured to read code from the memory to implement any of the first through eighteenth aspects.

A twentieth aspect includes a computer program product comprising a computer-readable program medium comprising code stored thereupon, the code, when executed by a processor, causing the processor to implement any of the first through eighteenth aspects.

In addition to the features mentioned in each of the independent aspects enumerated above, some examples may show, alone or in combination, the optional features mentioned in the dependent aspects and/or as disclosed in the description above and shown in the figures.

What is claimed is:

1. A method for wireless communication, the method comprising:
selecting, with a first user device, a carrier to be a licensed carrier or an unlicensed carrier for a sidelink transmission; and
transmitting, with the first device, a sidelink signal on a channel in the selected carrier to a second user device.

2. The method of claim 1, further comprising:
reporting, with the first device, information of the selected carrier to a wireless access node.

3. The method of claim 1, wherein the sidelink signal comprises a medium access control (MAC) protocol data unit (PDU), and
wherein selecting the carrier comprises selecting, with the first device, the licensed carrier as the carrier for the sidelink transmission in response to a value of a highest priority of one or more logical channels in the MAC PDU being lower than a value of sidelink priority threshold.

4. The method of claim 3, wherein selecting the carrier further comprises selecting, with the first device, the unlicensed carrier for the sidelink transmission in response to the value of the highest priority being higher than the value of the sidelink priority threshold.

5. The method of claim 3, further comprising:
receiving, with the first user device, the value of the sidelink priority threshold from a wireless access node.

6. The method of claim 3, wherein the first user device is preconfigured with the sidelink priority threshold.

7. The method of claim 1, wherein selecting the carrier comprises selecting, with the first device, the licensed carrier as the carrier for the sidelink transmission in response to a medium access control (MAC) protocol data unit (PDU) of the sidelink signal including a sidelink signaling radio bearer or a sidelink MAC control element (CE).

8. The method of claim 1, further comprising:
receiving, with the first user device, a list of allowed carriers, each of the allowed carriers mapped to a sidelink logical channel for the sidelink transmission; and
wherein selecting the carrier comprises selecting, with the first user device, the carrier from the list.

9. The method of claim 1, further comprising:
receiving, with the first user device, indication information indicating whether each of one or more sidelink logical channels is allowed to be transmitted on the unlicensed carrier or the licensed carrier;
determining, with the first user device, that the unlicensed carrier is selected; and
selecting, with the first user device, a first sidelink logical channel during a logical channel prioritization (LCP) procedure in response to the indication information indicating that the first sidelink logical channel is allowed to be transmitted on the unlicensed carrier.

10. The method of claim 1, further comprising:
receiving, with the first user device, priority indication information indicating whether the unlicensed carrier or the licensed carrier has a higher priority for each of one or more sidelink logical channels for the sidelink transmission, wherein selecting the carrier comprises:
selecting the licensed carrier and an associated pool of resources in response to the licensed carrier having the higher priority than the unlicensed carrier; and
selecting the unlicensed carrier and an associated pool of resources in response to the unlicensed carrier having the higher priority than the licensed carrier.

11. The method of claim 1, further comprising:
receiving, with the first user device from a wireless access node, indication information indicating whether at least one of the unlicensed carrier or the licensed carrier is allowed to be used for the sidelink transmission for each of one or more quality of service (QOS) profiles, wherein selecting the carrier comprises:
selecting the licensed carrier in response to a medium access control (MAC) protocol data unit (PDU) to be transmitted including data of any of the one or more QoS profiles indicating that the unlicensed carrier is not allowed to be used for the sidelink transmission; and
selecting the unlicensed carrier in response to the MAC PDU to be transmitted including data of any of the one or more QoS profiles indicating that the licensed carrier is not allowed to be used for the sidelink transmission.

12. The method of claim 1, further comprising:
receiving, with the first user device from a wireless access node, a list of quality of service (QoS) profiles, each of the QoS profiles in the list indicating whether at least one of the unlicensed carrier or the licensed carrier is allowed to be used for the sidelink transmission; and
determining, with the first user device, that data of at least one QoS profile is included in a medium access control (MAC) protocol data unit (PDU),
wherein selecting the carrier comprises selecting the licensed carrier or the unlicensed carrier based on the list of QoS profiles and the data of the at least one QoS profile is included in the MAC PDU.

13. The method of claim 1, further comprising:
receiving, with the first user device from a wireless access node, a list of one or more sidelink logical channels, the list indicating whether at least one of the unlicensed carrier or the licensed carrier is allowed to be used for the sidelink transmission for each of the one or more sidelink logical channels in the list; and
determining, with the first user device, a sidelink logical channel is included in a medium access control (MAC) protocol data unit (PDU) for the sidelink transmission,
wherein selecting the carrier comprises selecting the licensed carrier or the unlicensed carrier based on the list of one or more sidelink logical channels and the sidelink logical channel included in the MAC PDU for the sidelink transmission.

14. The method of claim 1, further comprising:
detecting, with the first user device, a consistent listen-before-talk (LBT) failure for the carrier, a bandwidth part (BWP), or a destination identification,
wherein selecting the carrier comprises reselecting the carrier for the sidelink transmission in response to detecting the consistent LBT failure.

15. The method of claim 1, further comprising:
detecting, with the first user device, a listen-before-talk (LBT) failure indication;
incrementing, with the first user device, a LBT counter in response to the detecting; and
in response to incrementing, determining, with the first user device, whether the LBT counter has reached a maximum count value,
wherein selecting the carrier comprises reselecting, with the first user device, the carrier in response to LBT counter reaching the maximum count value.

16. The method of claim 1, further comprising:
before selecting the carrier, identifying, with the first user device, the unlicensed carrier as a candidate carrier in response to:
a number of listen-before-talk (LBT) failure indications being lower than a predetermined value during a last time window;
the first user device being configured with a user equipment (UE)-selected resource allocation mode when a LBT failure recovery is determined for the unlicensed carrier, a destination identification, or a sidelink bandwidth part (BWP); or
an LBT success for the unlicensed carrier, the destination identification, or the sidelink BWP.

17. The method of claim 16, further comprising:
determining, with the first user device, the LBT failure recovery in response to expiration of a timer that is started in response to determining a consistent LBT failure.

18. The method of claim 1, further comprising:
determining, with the first user device, a plurality of candidate carriers for the sidelink transmission, the plurality of candidate carriers comprising only unlicensed carriers; and
selecting, with the first user device, one or more carriers from among the plurality of candidate carriers according to an increasing order of numbers of listen-before-talk (LBT) failures for the plurality of the candidate carriers, starting from a lowest number of the numbers of LBT failures.

19. A wireless communications apparatus comprising a processor and a memory, wherein the processor is configured to read code from the memory to implement a method for wireless communication, the method comprising:
selecting, with a first user device, a carrier to be a licensed carrier or an unlicensed carrier for a sidelink transmission; and
transmitting, with the first device, a sidelink signal on a channel in the selected carrier to a second user device.

20. A computer program product comprising a non-volatile computer-readable program medium comprising code stored thereupon, the code, when executed by a processor, causing the processor to implement a method for wireless communication, the method comprising:
selecting, with a first user device, a carrier to be a licensed carrier or an unlicensed carrier for a sidelink transmission; and
transmitting, with the first device, a sidelink signal on a channel in the selected carrier to a second user device.
